(19) United States
(12) Patent Application Publication
(10) Pub. No.: US 2026/0105924 A1
(43) Pub. Date: Apr. 16, 2026

(54) AUDIO DECODER, AUDIO ENCODER AND METHOD FOR CODING FRAMES USING A PITCH FREQUENCY DEPENDENT SPECTRAL SHAPING

(71) Applicant: Fraunhofer-Gesellschaft zur Förderung der angewandten Forschung e.V., München (DE)

(72) Inventors: Christian HELMRICH, Berlin (DE); Guillaume FUCHS, Erlangen (DE); Goran MARKOVIC, Erlangen (DE); Markus SCHNELL, Erlangen (DE); Stefan REUSCHL, Erlangen (DE); Bernhard GRILL, Erlangen (DE)

(73) Assignee: Fraunhofer-Gesellschaft zur Förderung der angewandten Forschung e.V., München (DE)

(21) Appl. No.: 19/420,720

(22) Filed: Dec. 15, 2025

Related U.S. Application Data
(63) Continuation of application No. PCT/EP2024/066258, filed on Jun. 12, 2024.

(30) Foreign Application Priority Data
Jun. 16, 2023 (EP) 23179892.7

(51) Int. Cl. G10L 19/06

(52) U.S. Cl. CPC G10L 19/06

(57) ABSTRACT

Embodiments according to the invention comprise an audio decoder configured to, for a predetermined frame among consecutive frames, decode, from a data stream, a quantized spectrum, a linear prediction coefficient based spectral envelope representation and a fundamental frequency related parameter, and configured to determine a spectral shaping function from the linear prediction coefficient based spectral envelope representation using a first manner below a pitch frequency determined from the fundamental frequency related parameter, and a second manner above the pitch frequency, to spectrally shape the quantized spectrum using the spectral shaping function to obtain a dequantized spectrum and to reconstruct the predetermined frame using the dequantized spectrum. Furthermore, the audio decoder is configured so that the spectral shaping function is, at a predetermined spectral position, lower if the pitch frequency is spectrally higher than the predetermined spectral position, than compared to if the pitch frequency is spectrally lower than the predetermined spectral position.

### CROSS-REFERENCES TO RELATED APPLICATIONS

This application is a continuation of copending International Application No. PCT/EP2024/066258, filed Jun. 12, 2024, which is incorporated herein by reference in its entirety, and additionally claims priority from European Application No. EP 23 179 892.7, filed Jun. 16, 2023, which is incorporated herein by reference in its entirety.

Embodiments according to the invention are related to an audio decoder, an audio encoder and a method for coding frames using a pitch frequency dependent spectral shaping.

Embodiments are related to low-frequency emphasis and deemphasis for low-bitrate coding of tonal audio.

### BACKGROUND OF THE INVENTION

In low-bitrate audio coding, for realizing spectral quantization noise shaping by means of a linear predictive coded (LPC) representation of a spectral envelope, audible coding artifacts, in particular in in low frequencies pose a problem. At low frequencies, the human auditory system is particularly sensitive to distortion caused by a low coding SNR (Signal to Noise Ratio).

Therefore, it is desired to get a concept for audio coding which makes a better compromise between an acoustic quality and a signaling effort especially, but not exclusively, in low frequencies, where the human auditory system is most sensitive to distortion.

This is achieved by the subject matter of the independent claims of the present application. Further embodiments according to the invention are defined by the subject matter of the dependent claims of the present application.

### SUMMARY

An embodiment may have an audio decoder configured to, for a predetermined frame among consecutive frames, decode, from a data stream, a quantized spectrum; a linear prediction coefficient based spectral envelope representation, and a fundamental frequency related parameter, determine a spectral shaping function from the linear prediction coefficient based spectral envelope representation using a first manner below a pitch frequency determined from the fundamental frequency related parameter, and a second manner above the pitch frequency, and spectrally shape the quantized spectrum using the spectral shaping function to obtain a dequantized spectrum, and reconstruct the predetermined frame using the dequantized spectrum, wherein the audio decoder is configured so that the spectral shaping function is, at a predetermined spectral position, lower if the pitch frequency is spectrally higher than the predetermined spectral position, than compared to if the pitch frequency is spectrally lower than the predetermined spectral position.

Another embodiment may have an audio decoder configured to, for a predetermined frame among consecutive frames, decode, from a data stream, a quantized spectrum; a linear prediction coefficient based spectral envelope representation, and a fundamental frequency related parameter, determine an intermediate version of a spectral shaping function from the linear prediction coefficient based spectral envelope representation, below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function, and spectrally shape the quantized spectrum using the spectral shaping function to obtain a dequantized spectrum, and reconstruct the predetermined frame using the dequantized spectrum.

Another embodiment may have an audio decoder configured to, for a predetermined frame among consecutive frames, decode, from a data stream, a quantized spectrum; a linear prediction coefficient based spectral envelope representation, and a coding mode parameter, if the coding mode parameter fulfils a predetermined criterion, determine a spectral shaping function from the linear prediction coefficient based spectral envelope representation using a first manner and, if the coding mode parameter does not fulfil the predetermined criterion, determine the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency, and spectrally shape the quantized spectrum using the spectral shaping function to obtain a dequantized spectrum, and reconstruct the predetermined frame using the dequantized spectrum.

Another embodiment may have an audio encoder configured to, for a predetermined frame among consecutive frames, determine a linear prediction coefficient based spectral envelope representation and a spectrum, determine an inverse of a spectral shaping function from the linear prediction coefficient based spectral envelope representation using a first manner below a pitch frequency, and a second manner above the pitch frequency, and spectrally shape the spectrum using the inverse of the spectral shaping function to obtain a shaped spectrum and quantize the shaped spectrum to obtain a quantized spectrum, and encode, into a data stream, the quantized spectrum; the linear prediction coefficient based spectral envelope representation, and a fundamental frequency related parameter from which the pitch frequency is determinable, wherein the audio encoder is configured so that the inverse of the spectral shaping function is, at a predetermined spectral position, higher if the pitch frequency is spectrally higher than the predetermined spectral position, than compared to if the pitch frequency is spectrally lower than the predetermined spectral position.

Another embodiment may have an audio encoder configured to, for a predetermined frame among consecutive frames, determine a linear prediction coefficient based spectral envelope representation and a spectrum, determine an intermediate version of a spectral shaping function or of an inverse of the spectral shaping function from the linear prediction coefficient based spectral envelope representation, below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function or a local spectral increase in the intermediate version of the inverse of the spectral shaping function by aligning an increase function with an interval whose upper limit coincides with, or is, by a predetermined guard interval width value offset towards DC from, the pitch frequency, and applying the increase function thus aligned to the intermediate version of the inverse of the spectral shaping function, and spectrally shape the spectrum using the inverse of the spectral shaping function to obtain a shaped spectrum and quantize the shaped spectrum to obtain a quantized spectrum, and encode, into a data stream, the quantized spectrum; the linear prediction coefficient based spectral envelope representation, and a fundamental frequency related parameter from which the pitch frequency is determinable.

Another embodiment may have an audio encoder configured to, for a predetermined frame among consecutive frames, determine a linear prediction coefficient based spectral envelope representation, a spectrum and a coding mode parameter, if the coding mode parameter fulfils a predetermined criterion, determine a spectral shaping function from the linear prediction coefficient based spectral envelope representation using a first manner and, if the coding mode parameter does not fulfil the predetermined criterion, determine the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency, or if the coding mode parameter fulfils the predetermined criterion, determine an inverse of a spectral shaping function from the linear prediction coefficient based spectral envelope representation using a first manner and, if the coding mode parameter does not fulfil the predetermined criterion, determine the inverse of the spectral shaping function from the linear prediction coefficient based spectral envelope representation using a second manner, wherein the first manner and the second manner differ so that a difference between the inverse of the spectral shaping function as determined from the linear prediction coefficient based spectral envelope representation using the first manner in case of the coding mode parameter fulfilling the predetermined criterion, minus the inverse of the spectral shaping function as determined from the linear prediction coefficient based spectral envelope representation using the second manner in case of the coding mode parameter not fulfilling the predetermined criterion, comprises an inverse of a dip below a pitch frequency, and spectrally shape the spectrum using the inverse of the spectral shaping function to obtain a shaped spectrum and quantize the shaped spectrum to obtain a quantized spectrum, and encode, into a data stream, the quantized spectrum; the linear prediction coefficient based spectral envelope representation, and the coding mode parameter.

Another embodiment may have a method for a predetermined frame among consecutive frames, the method comprising: decoding, from a data stream, a quantized spectrum, a linear prediction coefficient based spectral envelope representation, and a fundamental frequency related parameter; determining a spectral shaping function from the linear prediction coefficient based spectral envelope representation using a first manner below a pitch frequency determined from the fundamental frequency related parameter, and a second manner above the pitch frequency, spectrally shaping the quantized spectrum using the spectral shaping function to obtain a dequantized spectrum, and reconstructing the predetermined frame using the dequantized spectrum; wherein the determination of the spectral shaping function is performed, so that the spectral shaping function is, at a predetermined spectral position, lower if the pitch frequency is spectrally higher than the predetermined spectral position, than compared to if the pitch frequency is spectrally lower than the predetermined spectral position.

Another embodiment may have a method for a predetermined frame among consecutive frames, the method comprising: decoding, from a data stream, a quantized spectrum; a linear prediction coefficient based spectral envelope representation, and a fundamental frequency related parameter; determining an intermediate version of a spectral shaping function from the linear prediction coefficient based spectral envelope representation, below a pitch frequency determined from the fundamental frequency related parameter, forming a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function; and spectrally shaping the quantized spectrum using the spectral shaping function to obtain a dequantized spectrum, and reconstructing the predetermined frame using the dequantized spectrum.

Another embodiment may have a method for a predetermined frame among consecutive frames, the method comprising: decoding, from a data stream, a quantized spectrum; a linear prediction coefficient based spectral envelope representation, and a coding mode parameter; if the coding mode parameter fulfils a predetermined criterion, determining a spectral shaping function from the linear prediction coefficient based spectral envelope representation using a first manner and, if the coding mode parameter does not fulfil the predetermined criterion, determining the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency; and spectrally shaping the quantized spectrum using the spectral shaping function to obtain a dequantized spectrum; and reconstructing the predetermined frame using the dequantized spectrum.

Another embodiment may have a method for a predetermined frame among consecutive frames, the method comprising: determining a linear prediction coefficient based spectral envelope representation and a spectrum, determining an inverse of a spectral shaping function from the linear prediction coefficient based spectral envelope representation using a first manner below a pitch frequency, and a second manner above the pitch frequency, spectrally shaping the spectrum using the inverse of the spectral shaping function to obtain a shaped spectrum and quantize the shaped spectrum to obtain a quantized spectrum, and encoding, into a data stream, the quantized spectrum, the linear prediction coefficient based spectral envelope representation, and a fundamental frequency related parameter from which the pitch frequency is determinable. wherein the determination of the inverse of the spectral shaping function is performed, so that the inverse of the spectral shaping function is, at a predetermined spectral position, higher if the pitch frequency is spectrally higher than the predetermined spectral position, than compared to if the pitch frequency is spectrally lower than the predetermined spectral position.

Another embodiment may have a method for a predetermined frame among consecutive frames, the method comprising: determining a linear prediction coefficient based spectral envelope representation and a spectrum, determining an intermediate version of a spectral shaping function or of an inverse of the spectral shaping function from the linear prediction coefficient based spectral envelope representation, below a pitch frequency determined from the fundamental frequency related parameter, forming a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function or a local spectral increase in the intermediate version of the inverse of the spectral shaping function by aligning an increase function with an interval whose upper limit coincides with, or is, by a predetermined guard interval width value offset towards DC from, the pitch frequency, and applying the increase function thus aligned to the intermediate version of the inverse of the spectral shaping function; and spectrally shaping the spectrum using the inverse of the spectral shaping function to obtain a shaped spectrum and quantizing the shaped spectrum to obtain a quantized spectrum, and encoding, into a data stream, the quantized spectrum; the linear prediction coefficient based spectral envelope representation, and a fundamental frequency related parameter from which the pitch frequency is determinable.

Another embodiment may have a method for a predetermined frame among consecutive frames, the method comprising: determining a linear prediction coefficient based spectral envelope representation, a spectrum and a coding mode parameter; if the coding mode parameter fulfils a predetermined criterion, determining a spectral shaping function from the linear prediction coefficient based spectral envelope representation using a first manner and, if the coding mode parameter does not fulfil the predetermined criterion, determining the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency, or if the coding mode parameter fulfils the predetermined criterion, determining an inverse of a spectral shaping function from the linear prediction coefficient based spectral envelope representation using a first manner and, if the coding mode parameter does not fulfil the predetermined criterion, determining the inverse of the spectral shaping function from the linear prediction coefficient based spectral envelope representation using a second manner, wherein the first manner and the second manner differ so that a difference between the inverse of the spectral shaping function as determined from the linear prediction coefficient based spectral envelope representation using the first manner in case of the coding mode parameter fulfilling the predetermined criterion, minus the inverse of the spectral shaping function as determined from the linear prediction coefficient based spectral envelope representation using the second manner in case of the coding mode parameter not fulfilling the predetermined criterion, comprises an inverse of a dip below a pitch frequency, and spectrally shaping the spectrum using the inverse of the spectral shaping function to obtain a shaped spectrum and quantizing the shaped spectrum to obtain a quantized spectrum, and encoding, into a data stream, the quantized spectrum; the linear prediction coefficient based spectral envelope representation, and the coding mode parameter.

Another embodiment may have a computer program for performing the methods according to invention, when the computer program runs on a computer.

Embodiments according to the invention comprise an audio decoder configured to, for a predetermined frame among consecutive frames, decode, from a data stream, a quantized spectrum, a linear prediction coefficient based spectral envelope representation and a fundamental frequency related parameter.

Furthermore, the decoder is configured to determine a spectral shaping function from the linear prediction coefficient based spectral envelope representation using a first manner below a pitch frequency determined from the fundamental frequency related parameter, and a second manner above the pitch frequency, to spectrally shape the quantized spectrum using the spectral shaping function to obtain a dequantized spectrum and to reconstruct the predetermined frame using the dequantized spectrum.

Furthermore, the audio decoder is configured so that the spectral shaping function is, at a predetermined spectral position, lower if the pitch frequency is spectrally higher than the predetermined spectral position, than compared to if the pitch frequency is spectrally lower than the predetermined spectral position.

The inventors recognized that an adaptation of an emphasis of spectral coefficients may be performed efficiently based on a pitch frequency, in order to improve an acoustic quality of a decoded audio signal.

The spectral shaping function may be modified differently in a portion above the pitch frequency in contrast to a portion below the pitch frequency. This may allow reducing a number and influence of artifacts in the reconstructed waveforms that are particularly prevalent at low frequencies, where the human auditory system is sensitive to such artifacts, for example, caused by a low coding SNR.

Hence, in other words, the inventors recognized that an adaptation of a coding SNR may be performed based on an adaptation of a spectral shaping function using the pitch frequency.

Furthermore, the inventors recognized that an information about such a pitch frequency may be obtained using a fundamental frequency related parameter. In many applications, such parameters are readily available in the data stream (e.g. in the form of a bitstream), and hence, pitch frequency information may be harvested without, or with minor, introduction of additional signaling overhead.

As an optional feature, the spectral shaping function may provide or represent one scale factor or scaling factor per spectral band. Hence, a spectral shaping may comprise a multiplication of each coefficient level with a respective scale factor.

With the spectral shaping function being lower for spectral positions below the pitch frequency than above the pitch frequency, low frequency spectral coefficients may be deemphasized in order to compensate for an encoder sided emphasis that allows the provision of a higher coding SNR, in order to prevent the artifacts.

According to an embodiment of the invention, an amount at which the spectral shaping function is, at the predetermined spectral position, lower if the pitch frequency is spectrally higher than the predetermined spectral position, than compared to if the pitch frequency is spectrally lower than the predetermined spectral position, corresponds to a dip function with using a distance between the predetermined spectral position and the pitch frequency as an attribute of the dip function.

Optionally, the dip function may comprise the shape of a parabola, at least approximately. The inventors recognized that a local modification of a spectral shaping function, e.g. an intermediate spectral shaping function, according to a dip function may allow providing a manipulation, e.g. in the sense of emphasis or de-emphasis respectively, so that good acoustic properties of the reconstructed signal may be achieved.

Embodiments according to the invention comprise an audio decoder configured to, for a predetermined frame among consecutive frames, decode, from a data stream, a quantized spectrum, a linear prediction coefficient based spectral envelope representation, and a fundamental frequency related parameter. Here, the decoder is configured to realize the dip by means of a sequential approach. The decoder determines an intermediate version of a spectral shaping function from the linear prediction coefficient based spectral envelope representation, and forms, below a pitch frequency determined from the fundamental frequency related parameter, a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function.

Moreover, the decoder is configured to spectrally shape the quantized spectrum using the spectral shaping function to obtain a dequantized spectrum, and to reconstruct the predetermined frame using the dequantized spectrum.

The inventors recognized that the determination of the spectral shaping function may, for example, be performed efficiently in a sequential approach. First, the intermediate version of the spectral shaping function may be determined based on the linear prediction coefficient, LPC, based spectral envelope representation. Optionally, such an intermediate spectral shaping function may be determined according to a desired noise shaping above the pitch frequency, but for the whole frequency range of the intermediate shaping function. In particular, the intermediate spectral shaping function may be determined according to conventional approaches.

Then, such an intermediate shaping function may be adapted below the pitch frequency, using the reduction function. This may allow an effortless integration of the inventive approach into existing frameworks, since only a correction of the intermediate version of a spectral shaping function, e.g. a conventionally determined spectral shaping function, may have to be added. Furthermore, in line with the following embodiments, an application of the reduction function may be selectively activated, e.g. based on a coding mode parameter, for example, only for frames comprising significant tonal low frequency signal portions.

Hence, as an example, based on the intermediate version of the spectral shaping function the spectral shaping function may be obtained. In particular, the decoder may, for example, be configured to determine an intermediate version of a spectral shaping function from the linear prediction coefficient based spectral envelope representation, e.g. according to conventional approaches, and may, for example, be configured to form (e.g. thereafter, e.g. sequentially thereafter), below a pitch frequency determined from the fundamental frequency related parameter, a local spectral reduction in the intermediate version of the spectral shaping function by aligning a reduction function with an interval whose upper limit coincides with, or is, by a predetermined guard interval width value offset towards DC from, the pitch frequency, and to apply the reduction function thus aligned to the intermediate version of the spectral shaping function, in order to obtain the spectral shaping function.

As an example, the spectral shaping function may be the result of the application of the aligned reduction function to the intermediate version of the spectral shaping function.

According to some embodiments the below-pitch-frequency dip idea manifests itself in a different processing of frames coded in one mode compared to the processing of frames coded in a different mode. Here, the embodiments comprise an audio decoder configured to, for a predetermined frame among consecutive frames, decode, from a data stream, a quantized spectrum, a linear prediction coefficient based spectral envelope representation, and a coding mode parameter. Furthermore, the decoder is configured to, if the coding mode parameter fulfils a predetermined criterion, determine a spectral shaping function from the linear prediction coefficient based spectral envelope representation using a first manner and, if the coding mode parameter does not fulfil the predetermined criterion, determine spectral the shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency.

Furthermore, the decoder is configured to spectrally shape the quantized spectrum using the spectral shaping function to obtain a dequantized spectrum, and to reconstruct the predetermined frame using the dequantized spectrum.

The inventors recognized that a determination of the spectral shaping function may be performed based on a coding mode parameter, so that in one case or manner, the spectral shaping function may comprise different sections below and above a pitch frequency, for implementing individual emphasizes, and wherein in the other case or manner, the spectral shaping function may not comprise a lower and higher frequency section with individually adapted emphasis correction.

Comparing the coding mode parameter to a predetermined criterion, e.g. a tonality criterion, a switching between activated emphasis adaptation or correction and deactivated emphasis adaptation or correction may be performed. Accordingly, in some cases additional computational effort may be avoided.

As defined above, the spectral shaping functions as obtained using the first and second manner may differ in a dip, for example in the form of a parabola, below the pitch frequency. The inventors recognized that an emphasis correction according to a dip function may yield good acoustic results with regard to the reconstructed frame.

As an example, the coding mode parameter may comprise an information about a tonality of the encoded audio signal. Generally speaking, the “tonality” may indicate a measure describing how condensed the audio signal's energy is at a certain point of time in the respective spectrum associated with that point in time. If the energy is spread much, such as in noisy or transient temporal phases of the audio signal, then the tonality is low. But if the energy is substantially condensed to one or more spectral peaks, then the tonality is high. Embodiments may allow improving an acoustic quality of tonal audio in low frequencies in particular, hence, the inventive adaptation of the spectral shaping may be switchably activated depending on an audio signal having such characteristics or not by using the encoder's frame mode indication: frames being non-tonal may be left unmodified with respect to the dip provision, while frames being coded using a mode for tonal frames may be subject to the dip provision modification. Since the frames to be subject to dip processing are already indicated in the data stream by indicating a corresponding coding mode, it might, according to an embodiment, be possible for the decoder to determine the pitch frequency without explicit transmission in the data stream.

It is to be noted that embodiments according to the invention, in particular the above discussed embodiments, may be supplemented by any of the features of other embodiments according the invention, both individually or taken in combination.

Hence, as an example, an audio decoder configured to decode a fundamental frequency related parameter, may as well be configured to perform a determination of the spectral shaping function according to a first and/or second manner based on a coding mode parameter. Optionally, the determination of the spectral shaping function with emphasis correction according to the first or respectively second manner may be performed sequentially, e.g. based on the determination of an intermediate spectral shaping function. In other words, for the sake of the brevity of the disclosure of the invention herein, it is to be noted that features according to embodiments are combinable, unless explicitly stated otherwise.

Furthermore, embodiments according to the invention comprise encoders corresponding to the decoders as disclosed herein, as well as methods corresponding the encoders and decoders as disclosed herein.

It is to be noted that corresponding encoders and methods as described herein may be based on the same considerations as the decoders described herein. The encoders and methods can, by the way, be completed with all features and functionalities, both individually and in combination, which are also described with regard to the decoders—and vice versa.

Accordingly, embodiments according to the invention comprise a method for a predetermined frame among consecutive frames, the method comprising: decoding, from a data stream, a quantized spectrum, a linear prediction coefficient based spectral envelope representation, and a fundamental frequency related parameter. Furthermore, the method comprises determining a spectral shaping function from the linear prediction coefficient based spectral envelope representation using a first manner below a pitch frequency determined from the fundamental frequency related parameter, and a second manner above the pitch frequency, spectrally shaping the quantized spectrum using the spectral shaping function to obtain a dequantized spectrum, and reconstructing the predetermined frame using the dequantized spectrum. The determination of the spectral shaping function is performed so that the spectral shaping function is, at a predetermined spectral position, lower if the pitch frequency is spectrally higher than the predetermined spectral position, than compared to if the pitch frequency is spectrally lower than the predetermined spectral position.

Furthermore, embodiments comprise a method, for a predetermined frame among consecutive frames, the method comprising decoding, from a data stream, a quantized spectrum; a linear prediction coefficient based spectral envelope representation, and a fundamental frequency related parameter. Furthermore, the method comprises determining an intermediate version of a spectral shaping function from the linear prediction coefficient based spectral envelope representation, below a pitch frequency determined from the fundamental frequency related parameter, forming a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function. The method further comprises spectrally shaping the quantized spectrum using the spectral shaping function to obtain a dequantized spectrum, and reconstructing the predetermined frame using the dequantized spectrum.

Embodiments comprise a method, for a predetermined frame among consecutive frames, the method comprising, decoding, from a data stream, a quantized spectrum; a linear prediction coefficient based spectral envelope representation, and a coding mode parameter. Furthermore, the method comprises, if the coding mode parameter fulfils a predetermined criterion, determining a spectral shaping function from the linear prediction coefficient based spectral envelope representation using a first manner and, if the coding mode parameter does not fulfil the predetermined criterion, determining the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency. The method further comprises spectrally shaping the quantized spectrum using the spectral shaping function to obtain a dequantized spectrum, and reconstructing the predetermined frame using the dequantized spectrum.

Embodiments comprise a method, for a predetermined frame among consecutive frames, the method comprising determining a linear prediction coefficient based spectral envelope representation and a spectrum, determining an inverse of a spectral shaping function from the linear prediction coefficient based spectral envelope representation using a first manner below a pitch frequency, and a second manner above the pitch frequency, spectrally shaping the spectrum using the inverse of the spectral shaping function to obtain a shaped spectrum and quantize the shaped spectrum to obtain a quantized spectrum, and encoding, into a data stream, the quantized spectrum, the linear prediction coefficient based spectral envelope representation, and a fundamental frequency related parameter from which the pitch frequency is determinable. Furthermore, the determination of the inverse of the spectral shaping function is performed so that the inverse of the spectral shaping function is, at a predetermined spectral position, higher if the pitch frequency is spectrally higher than the predetermined spectral position, than compared to if the pitch frequency is spectrally lower than the predetermined spectral position.

Embodiments comprise a method, for a predetermined frame among consecutive frames, the method comprising determining a linear prediction coefficient based spectral envelope representation and a spectrum, determining an intermediate version of a spectral shaping function or of an inverse of the spectral shaping function from the linear prediction coefficient based spectral envelope representation, below a pitch frequency determined from the fundamental frequency related parameter, forming a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function or a local spectral increase in the intermediate version of the inverse of the spectral shaping function by aligning an increase function with an interval whose upper limit coincides with, or is, by a predetermined guard interval width value offset towards DC from, the pitch frequency, and applying the increase function thus aligned to the intermediate version of the inverse of the spectral shaping function. The method further comprises spectrally shaping the spectrum using the inverse of the spectral shaping function to obtain a shaped spectrum and quantizing the shaped spectrum to obtain a quantized spectrum, and encoding, into a data stream, the quantized spectrum; the linear prediction coefficient based spectral envelope representation, and a fundamental frequency related parameter from which the pitch frequency is determinable.

Embodiments comprise a method, for a predetermined frame among consecutive frames, the method comprising determining a linear prediction coefficient based spectral envelope representation, a spectrum and a coding mode parameter.

Furthermore, the method comprises, if the coding mode parameter fulfils a predetermined criterion, determining a spectral shaping function from the linear prediction coefficient based spectral envelope representation using a first manner and, if the coding mode parameter does not fulfil the predetermined criterion, determining the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency.

Alternatively, the method comprises, if the coding mode parameter fulfils the predetermined criterion, determining an inverse of a spectral shaping function from the linear prediction coefficient based spectral envelope representation using a first manner and, if the coding mode parameter does not fulfil the predetermined criterion, determining the inverse of the spectral shaping function from the linear prediction coefficient based spectral envelope representation using a second manner, wherein the first manner and the second manner differ so that a difference between the inverse of the spectral shaping function as determined from the linear prediction coefficient based spectral envelope representation using the first manner in case of the coding mode parameter fulfilling the predetermined criterion, minus the inverse of the spectral shaping function as determined from the linear prediction coefficient based spectral envelope representation using the second manner in case of the coding mode parameter not fulfilling the predetermined criterion, comprises an inverse of a dip below a pitch frequency.

The method further comprises spectrally shaping the spectrum using the inverse of the spectral shaping function to obtain a shaped spectrum and quantizing the shaped spectrum to obtain a quantized spectrum, and encoding, into a data stream, the quantized spectrum; the linear prediction coefficient based spectral envelope representation, and the coding mode parameter.

### BRIEF DESCRIPTION OF THE DRAWINGS

Embodiments of the present invention will be detailed subsequently referring to the appended drawings, in which:

FIG. 1 shows a schematic view of a decoder according to embodiments of the invention;

FIG. 2 a-c shows schematic plots of spectral amplitudes (intensity) over spectral index (frequency) according to conventional approaches (a), and according to embodiments of the invention (b), (c); and

FIG. 3 shows a schematic view of an encoder according to embodiments of the invention.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

In low-bitrate audio coding realizing spectral quantization noise shaping by means of a linear predictive coded (LPC) representation of spectral envelope, the inventors recognized that it may be important to apply
signal adaptive emphasis of spectral (e. g., MDCT) coefficients before quantization,
corresponding deemphasis (i. e., inverse of emphasis) of the quantized coefficients
   to reduce audible coding artifacts in the waveforms reconstructed by the decoder. Such artifacts occur especially in low frequencies, where the human auditory system is most sensitive to distortion caused by a low coding SNR in the absence of (de)emphasis. In other words, the purpose of low-frequency (de)emphasis may, for example, be to increase the SNR in lower frequencies during audio coding incorporating time- or frequency-domain quantization.

Numerous adaptive low-frequency emphasis (ALFE) and corresponding deemphasis methods have been devised during the last two decades, most prominently in the 3GPP AMR-Wideband Plus (AMR-WB+) and Enhanced Voice Services (EVS) speech and music codecs. The former codec makes use of an ALFE approach adapted (i. e., controlled) by the values of the low-frequency spectral coefficients themselves. The advantage of such a solution is that no additional information needs to be transmitted to the decoder, so an increase in the coding bitrate is avoided. However, since only quantized versions of said spectral coefficients are available at the decoder, this ALFE process is not perfectly invertible, thus potentially causing additional coding artifacts. The EVS standard, on the other hand, addressed this lack of perfect invertibility by adapting the ALFE process in the TCX music coding part by way of the LPC coded (and reconstructed) noise shaping envelope, which can be regarded as a spectrally tilted and smoothed variant of the signal's spectral envelope, in each frame f. Again, no additional data must be sent to the decoder—the LPC envelope bits are already included in the bitstream. Thus, such an LPC based ALFE process, described in, e. g, US patent U.S. Ser. No. 10/176,817, can also be inverted perfectly. However, owing to the relatively low frequency resolution of LPC coded spectral envelopes at low frequencies, the perceptual benefit of LPC based ALFE is limited, and it was observed that especially tonal, harmonic signals benefit from further (de)emphasis.

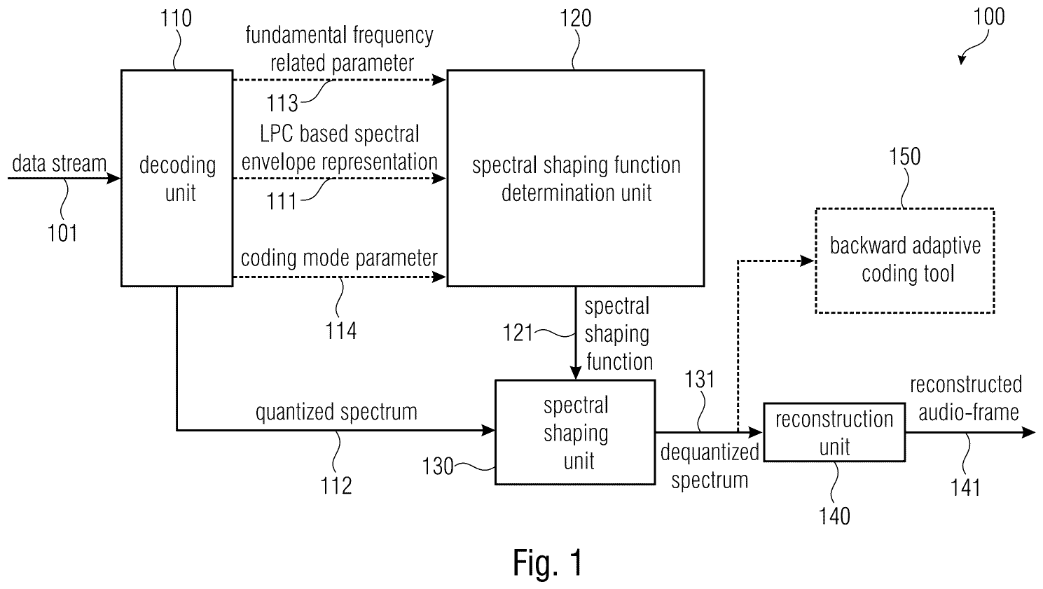

In the following reference is made to FIG. 1, showing a schematic view of a decoder according to embodiments of the invention, which may allow to address drawbacks of the above discussed prior approaches.

FIG. 1 shows a decoder 100 comprising a decoding unit 110, a spectral shaping function determination unit 120, a spectral shaping unit 130 and a reconstruction unit 140.

Decoding unit 110 is configured to decode an incoming data stream 101 in order to obtain a LPC based spectral envelope representation 111 and a quantized spectrum 112. Optionally, as shown with dashed lines, the decoding unit 110 may be configured to decode a fundamental frequency related parameter 113 and/or a coding mode parameter 114.

The data stream 101 may comprise an encoded information about a predetermined frame, e.g. audio frame, among consecutive frames. Decoding may, for example, be performed according to any suitable approach, for example such as using entropy decoding, such as context adaptive variable length decoding or context adaptive binary arithmetic decoding. In particular, decoding unit 110 may be configured to decode, from the data stream 101, the quantized spectrum 112 by entropy decoding and/or in form of spectral coefficient levels of an MDCT

As a first example, the spectral shaping function determination unit 120 may be configured to determine a spectral shaping function 121 from the linear prediction coefficient based spectral envelope representation 111 using a first manner below a pitch frequency determined from the fundamental frequency related parameter 113, and a second manner above the pitch frequency.

The fundamental frequency related parameter 113 may, for example, comprise an information about the lowest frequency of a periodic waveform of quantized spectrum 112. Hence, parameter 113 may describe an information about a first harmonic frequency of the quantizes spectrum 112. Based thereon, as explained above, the pitch frequency may be determined. This way, using already (e.g. according to conventional approaches) present encoded information, according to embodiments, a threshold frequency, in the form of the pitch frequency may be determined according to which the spectral shaping function can be manipulated (e.g. emphasized or de-emphasized), in order to achieve a desired SNR for a respective frequency region.

The spectral shaping function determination unit 120 is configured to determine the spectral shaping function 121, so that the spectral shaping function 121 is, at a predetermined spectral position, lower if the pitch frequency is spectrally higher than the predetermined spectral position, than compared to if the pitch frequency is spectrally lower than the predetermined spectral position.

As an example and in other words, a spectral envelope, as defined by the LPC based spectral envelope representation 111 is lowered in a low frequency region, namely the spectral position below the pitch frequency. Hence, an encoder sided emphasis may be compensated, allowing artifact mitigation in low frequency regions.

The spectral shaping function 121 is provided to the spectral shaping unit 130 in order to scale and dequantize the quantized spectrum, in order to obtain the dequantized spectrum 131, which is then forwarded to reconstruction unit 140 in order to determine the reconstructed audio frame 141.

Optionally, the reconstruction unit 140 may be configured to reconstruct the predetermined frame 141 using the dequantized spectrum by applying a spectrum-to-time transformation to the quantized spectrum, and/or using an overlap-add aliasing cancellation process with respect to one or more temporally neighboring frames.

According to the above, first example, optionally, no coding mode parameter 114 may be present in the data stream 101 and/or such a coding mode parameter 114 may not be decoded and/or considered by decoder 100.

As a second example, using the LPC based spectral envelope representation 111, the spectral shaping function determination 120 unit may be configured to determine an intermediate version of the spectral shaping function 121. The intermediate version may, for example, be a version of the spectral shaping function 121, wherein no emphasis compensation is yet incorporated.

Furthermore, the spectral shaping function determination unit 120 may optionally be configured to, below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function.

In other words, the spectral shaping function determination unit 120 may be configured to determine a correction function, namely the reduction function, based on which, e.g. multiplicatively, the intermediate spectral shaping function is adapted in order to incorporate an emphasis correction in a low frequency region.

The processing thereon, e.g. from quantized spectrum 112 and spectral shaping function 121 to reconstructed audio-frame 141 may be performed as explained with regard to the first example. Again, optionally, no coding mode parameter 114 may be present in the data stream 101 and/or such a coding mode parameter 114 may not be decoded and/or considered by decoder 100.

According to a third example, the determination of the spectral shaping function may be performed based on a decoding of the LPC based spectral envelope representation 111, and the coding mode parameter 114. As an example, in this case, optionally, no fundamental frequency related parameter 113 may be present in the data stream 101 and/or such a fundamental frequency related parameter 113 may not be decoded and/or considered by decoder 100.

In the above case, the spectral shaping function determination unit120 may be configured to, if the coding mode parameter 114 fulfils a predetermined criterion, determine a spectral shaping function 121 from the linear prediction coefficient based spectral envelope representation 111 using a first manner and, if the coding mode parameter 114 does not fulfil the predetermined criterion, determine the spectral shaping function from the linear prediction coefficient based spectral envelope representation 111 using a second manner, wherein the first manner and the second manner differ so that a difference between the spectral shaping function as determined from the linear prediction coefficient based spectral envelope representation 111 using the first manner in case of the coding mode parameter 114 fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency.

As an example, there may be frames having tonal low frequency portions for which an inventive encoding with encoder sided emphasis of said portions and decoder-sided de-emphasis of said portions may be highly advantageous and on the other hand some frames may not comprise such portions. Hence, the inventive determination of the spectral shaping function may be switchably selected, e.g. according to said coding mode parameter 114. Hence, computational costs may be kept low.

The processing thereon, e.g. from quantized spectrum 112 and spectral shaping function 121 to reconstructed audio-frame 141 may be performed as explained with regard to the first and second example.

Furthermore, the pitch frequency may optionally be determined by the spectral shaping function determination unit, for example based on the quantized spectrum 112 (not shown), e.g. without usage of a fundamental frequency related parameter 113, or based on the quantized spectrum 112 along with the LPC based envelops representation by determining, based thereon, an intermediate dequantized spectrum and determining, based on the latter, a pitch frequency. As the current frame is, in that case, already indicated to be likely tonal, the self-determination of the pitch frequency might be sufficiently accurate. The encoder would not have to transmit additional information. Alternatively, however, the fundamental frequency related parameter 113 might be transmitted in the data stream.

In particular, it is to be noted that decoder 100 may optionally be configured to, if the coding mode parameter 114 fulfils the predetermined criterion, decode, from the data stream 101, a fundamental frequency related parameter 113 for the predetermined frame, and to derive the pitch frequency based on the fundamental frequency related parameter.

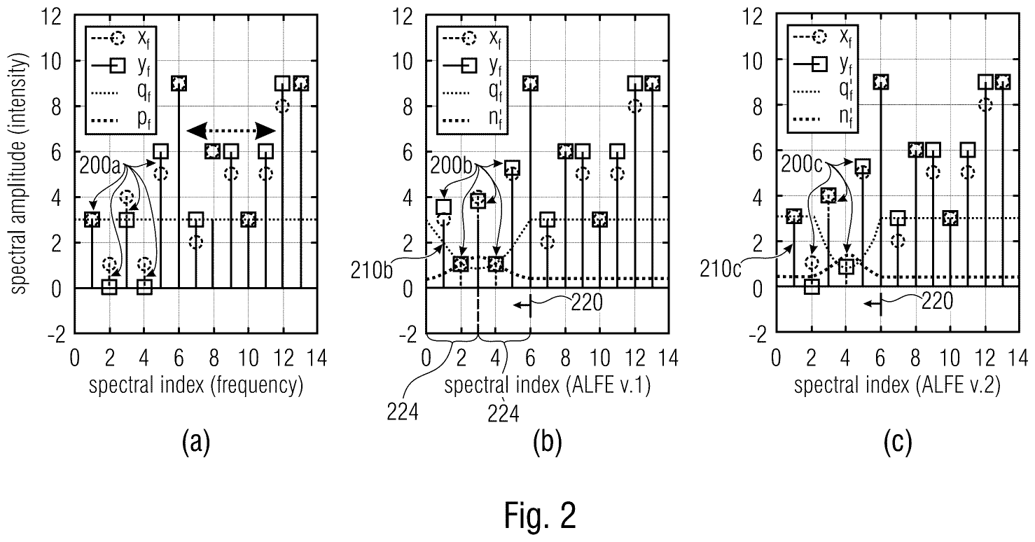

Furthermore, the dip may optionally follow a dip function and the audio decoder 100 is optionally configured to determine the dip function in a manner depending on the pitch frequency so that the dip function comprises a local extremum at half of the pitch frequency, monotonically deceases—or even strictly monotonically decreases—between zero-frequency and half of the pitch frequency, and monotonically—or even strictly monotonically—increases between half of the pitch frequency and the pitch frequency, as will be discussed in the context of FIG. 2 b (NOTE: here, the dip function is negative and its input/attribute is usual frequency so that the dip function is actually a “dip”, here extending over the whole reach of the pitch frequency).

As another optional feature, the dip function may have a dip shape, which is independent from the pitch frequency and has a dip interval width whose upper limit is aligned with the pitch frequency, and the difference is zero for frequencies between zero frequency and the pitch frequency minus the dip interval width, e.g. as will be discussed in the context of FIG. 2 c.

The determination of such a dip function, e.g. as a correction function or a reduction function for the intermediate spectral shaping function may be performed in the spectral shaping function determination unit.

However, with regard to the above three examples, it is to be noted that as shown in FIG. 2 any combination of features of said examples may be present in an embodiment according to the invention. Hence, a switchable activation of an inventive emphasis correction may be implemented based on the coding mode parameter 114, whilst determining a respective pitch frequency based on the fundamental frequency related parameter 113. In addition, an emphasis correction may be performed in the form of spectrally lower and higher sections, e.g. as explained according to the first example, or with the more distinct adaptation according to a dip function. Furthermore any of these cases may be adapted towards a sequential approach wherein an intermediate spectral shaping function is determined and afterwards amended.

As a further example, audio decoder 100, configured in accord with the first example, may optionally additionally be configured to decode, from the data stream 101, a coding mode parameter 114 for each of the consecutive frames, and to decide based on the coding mode parameter 114 so as to, for frames for which the coding mode parameter fulfils a predetermined criterion, decode a fundamental frequency related parameter from the data stream 113, determine a spectral shaping function 121 from the linear prediction coefficient based spectral envelope representation 111 using the first manner below a pitch frequency determined from the fundamental frequency related parameter, and the second manner above the pitch frequency, and for frames for which the coding mode parameter does not fulfil the predetermined criterion, determine a spectral shaping function 121 from the linear prediction coefficient based spectral envelope representation 111 using one manner over all frequencies.

Accordingly, audio decoder 100, for example configured according to the first or the above explained example, may optionally additionally be configured to, determine the spectral shaping function 121 from the linear prediction coefficient based spectral envelope representation 111, by determining an intermediate version of the spectral shaping function from the linear prediction coefficient based spectral envelope representation and below a pitch frequency determined from the fundamental frequency related parameter, to form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function.

In the same regard, audio decoder 100, for example configured according to the second example, may optionally additionally be configured to decode, from the data stream 101, a coding mode parameter 114 for each of the consecutive frames, and decide based on the coding mode parameter 114 so as to, for frames for which the coding mode parameter fulfils a predetermined criterion, decode the fundamental frequency related parameter 113 from the data stream 101, determine an intermediate version of a spectral shaping function from the linear prediction coefficient based spectral envelope representation, below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function, and for frames for which the coding mode parameter 114 does not fulfil the predetermined criterion, determine the spectral shaping function 121 so as to be equal to the intermediate version of the spectral shaping function.

FIG. 2 illustrates the need for improved ALFE below the fundamental frequency of tonal and/or harmonic audio signals, e.g. as may be inventively indicated by the pitch frequency, along with particular realizations of the present invention.

As another optional feature, decoder 100 may comprise a backward adaptive coding tool 150. Using the backward adaptive coding tool 150, a correlation between already decoded frames and subsequently decoded frames, such as temporally following frames of the same audio channel or one or more frames of another channel, may, for example, be exploited in order to improve an efficiency of the decoding. Therefore, as shown, tool 150 may be provided with spectrum 131. For instance, such a reconstructed spectrum 131 may be used to perform synthesized filling of zero-quantized portions in subsequently decoded frames, or to perform MS (mid/side decoding) or to perform spectrum prediction and prediction residual decoding. As another optional feature, backward adaptive coding tool 150 may be provided with additionally encoded parameters in order to perform or guide or control such an improved decoding, e.g. in the form of a prediction, e.g. from decoding unit 1010 which would decode such parameters from the data stream.

For example, using the optional backward adaptive coding tool 150, decoder 100 may be configured to perform a frequency-domain prediction, e.g. in accordance with MPEG-H Audio (e.g. ISO/IEC (MPEG-H), International Standard 23008-3:2022, “High efficiency coding and media delivery in heterogeneous environments-Part 3: 3D audio,” August 2022.) or long-term prediction (LTP) as in AAC (1990s years). An approach in accordance with MPEG-H Audio may be used according to U.S. application Ser. No. 16/802,397. An approach according to “improved LTP” may be used according to Goran Markovic et al. (application, 2020/2021). According to embodiments, different variants may be used. As an example, a fundamental frequency parameter, for example a pitch information, may be used for such a prediction. Accordingly, a respective fundamental frequency information, e.g. pitch frequency information, may be provided to the backward adaptive coding tool 150. Such an information may be encoded in data stream 101 and hence be decoded using decoding unit 110, e.g. in the form of the fundamental frequency related parameter 113.

FIG. 2 shows schematic plots of spectral amplitudes (intensity) over spectral index (frequency) according to conventional approaches (a) and according to embodiments of the invention (b) and (c).

In FIG. 2, p_{f} is a pitch value (e.g. pitch frequency), measured in units of spectral bin indices, for a given frame f. For better visibility, p_{f} is drawn in FIG. 2 a as the distance between harmonics, which may be equivalent to the index of the fundamental tone, hence, as an example 6 (Please note, that p_{f} may as well be indicated in FIG. 2 between indices 0 and 6 and/or exactly at index 6). x_{f} and y_{f} are the input and reconstructed (after quantization) spectra, respectively, for frame f, with y_{f}(i)=q_{f}(i)·round(x_{f}(i)/q_{f}(i))=q_{f}(i)·round(x_{f}(i)·n_{f}(i)), where i is a bin index and q_{f}(i) is the quantization step size at every i. q_{f} may hence represent the spectral shaping function and may define the quantization stepsize. As shown in FIG. 2 a, in the absence of ALFE, q_{f} is typically constant across i, but according to this aspect of the invention, q′_{f} exhibits a dip, e.g. a parabola-shaped dip between bin index 0 and p_{f} (see FIGS. 2 b and 2 c). The corresponding encoder-side emphasis (or normalization) factors n′_{f} may follow a bell shape in the same spectral range.

In other words, FIG. 2 shows schematic plots of (a): result of spectral quantization in frame f with fixed step-size q_{f}=3 (and, accordingly but not shown in FIG. 2 a, n_{f}=1/3) across the spectrum (note a relatively coarse quantization 200a below the fundamental frequency at spectral index 6. In other words, the interval below spectral index 6 may represent a low frequency region, wherein the human auditory system is sensitive to low coding SNR and hence such a coarse quantization) (b): result of spectral quantization with adaptive low-frequency deemphasis whose spectral range is proportional to p_{f} (note the finer quantization 200b and parabolic shape 210b (as an example of a dip function) of the product of quantization step-size and deemphasis values below spectral index 6). In other words, below a pitch frequency represented by spectral index 6, an improved quantization and a mitigation of coding artifacts may be achieved (c): same as (b) but with adaptive low-frequency deemphasis whose spectral range is fixed (4 spectral indices, e.g. as shown from spectral indices 2 to 6; dip function 210c; improved quantization 200c).

As show in FIG. 2 b, optionally, an amount at which the spectral shaping function 121 is, at the predetermined spectral position, lower if the pitch frequency, e.g. p_{f}, e.g. as represented by spectral index 6, is spectrally higher than the predetermined spectral position, than compared to if the pitch frequency is spectrally lower than the predetermined spectral position, may correspond to a dip function, e.g. 210 b, with using a distance between the predetermined spectral position and the pitch frequency as an attribute of the dip function. As explained above, the dip function may be parabola-shaped.

Referring to FIG. 2 b in particular, as an optional feature, the dip function 210b may be determined in a manner depending on the pitch frequency, e.g. as represented by spectral index 6, so that the dip function comprises a local extremum at half of the pitch frequency (hence spectral index 3), monotonically—or even strictly monotonically—increases between zero-frequency and half of the pitch frequency (see section 224), and monotonically—or even strictly monotonically—decreases between half of the pitch frequency and the pitch frequency (see section 222). It is to be noted that here, the dip function is to describe the amount of reduction and may, thus, be the absolute of the dip shape. Further, here, the dip function's input/attribute is defined to be the distance from the pitch frequency (towards DC, see 220) so that the dip function may actually be a “hill”, here extending over the whole reach of the pitch frequency) and it is defined from right to left which makes no difference in the explicit examples described so far, as, for instance, the parabolic shape is symmetric anyway, but the hill/dip shape may alternatively, for all embodiments described herein, by asymmetric.

Furthermore, as illustrated in FIG. 2 b, in general, a decoder, e.g. 1000, according to embodiments, may be configured to determine a reduction function for an adaptation of an intermediate spectral shaping function in a manner depending on the pitch frequency.

As explained above, FIG. 2 a shows a conventional quantization stepsize which is constant, q_{f}=3 corresponding, as an example, to a constant spectral shaping function in order to scale a respective spectrum. Such a spectral scaling, according to the constant quantization stepsize (in the example, q_{f}=3) may represent an intermediate spectral shaping function according to embodiments, which may be identical to the spectral shaping function above the pitch frequency. In the example of FIG. 2, q′_{f} is constant above the pitch frequency (index 6) in FIGS. 2 b and 2 c.

In other words, the intermediate spectral shaping function may be represented by the quantization stepsize of q_{f} over the whole frequency range. Hence, depending on the pitch frequency, determining a location for the de-emphasis of the intermediate spectral shaping or in other words scaling, may be performed, resulting in the adapted spectral shaping functions as represented by q′_{f} in FIGS. 2 b and 2 c, having the parabola shaped quantization step sizes in the interval between spectral indices 0 and 6 (FIG. 2 b). Hence, a shape of the parabola which extends over the whole interval between spectral indices 0 and 6 is dependent on the pitch frequency and may represent a corresponding reduction function.

Moreover, referring to FIG. 2 c in particular, optionally, the dip function 210c, as indicated by the quantization stepsize, may have a unimodal shape, which is independent from the pitch frequency, e.g. as represented by spectral index 6, and may have a dip interval width, e.g. as shown of 4 (spanning from index 2 to 6). Furthermore, the dip function may have a constant value for the distance being larger than the dip interval width, e.g. as shown from spectral index 0 to index 2. It is to be noted that here, the dip function 210 c may be positive and its input/attribute may be the distance from the pitch frequency towards DC (see 220) so that the dip function may actually be a “hill”, here extending over a fixed reach from the pitch frequency towards DC and being zero, or some other value, for frequencies nearer to DC).

Accordingly, a decoder according to embodiments, e.g. 1000, is optionally configured to determine the reduction function (e.g. the dips in FIGS. 2 b and 2 c) in a manner depending on the pitch frequency so that the reduction function comprises a local extremum leading to a local extreme of reduction of the spectral shaping function at a spectral position which corresponds to the pitch frequency minus a predetermined interval width value.

Optionally, as shown in FIG. 2 c the reduction function may be of no reducing strength between zero-frequency and the spectral position minus the interval width, of monotonically—or even strictly monotonically—deceasing reducing strength between the spectral position minus the interval width and the spectral position, and of monotonically—or even strictly monotonically—increasing reducing strength between the spectral position and the spectral position plus the interval width value.

A decoder, e.g. 1000, according to embodiments is optionally configured to determine the reduction function in a manner depending on the pitch frequency so that the reduction function comprises a local extremum leading to a local extreme of reduction of the spectral shaping function at a spectral position which depends on the pitch frequency. Referring to FIG. 2 b, the pitch frequency is represented as spectral index 6. depending thereon, the dip function is determined so that it extends in the interval between index 0 and 6, leading to an extremum at spectral index 3 which marks the local extremum of quantization step size reduction. In the particular case of FIG. 2 b, the spectral position of the extremum corresponds to half of the pitch frequency, namely 3. In contrast, for example using a fixed spectral range for the reduction function (in the example of 4), an example is provided wherein the extremum does not correspond to half of the pitch frequency.

With regard to FIGS. 2 b and 2 c, it is to be noted that in particular, parabola shaped reduction functions (in comparison to FIG. 2 a) may be used. In other words, a reduction function may be determined in a manner depending on the pitch frequency so that the reduction function comprises a local extremum leading to a local extreme of reduction of the quantization step size function at a spectral position which corresponds to half of the pitch frequency with the reduction function being of monotonically—or even strictly monotonically—deceasing reducing strength between zero-frequency and the spectral position, and monotonically—or even strictly monotonically—increasing reducing strength between the spectral position and the pitch frequency.

With regard to FIGS. 2 b and 2 c, it is to be noted that between the dip function and the pitch frequency, a guard interval may be present. In other words, an upper limit of a dip interval of the dip function may not be equal to the pitch frequency. Rather, it may alternatively be placed at a certain distance to the pitch frequency, such as offset relative to the pitch frequency at a certain distance towards DC. The distance may be fixed, i.e. independent from the pitch frequency, or may vary depending therefrom, and the distance—or guard interval—may be used to modify the embodiments where the dip covers the complete interval down to DC, or only a fixed dip width. Referring to FIGS. 2 b and 2 c, simply speaking, the parabola shaped dip of q′_{f} may not start at, or adjoin, shown position 220 and hence the pitch frequency.

For example, q′_{f} may comprise a first guard interval between a spectral index 0 (e.g. representing DC) and a first spectral index s₁ (e.g. an interval as shown between spectral indices 0 and 2 in FIG. 2 c), the dip, with a dip function which is defined and/or extends between spectral index s₁ and a second spectral index s₂ and a second guard interval between s₂ and the pitch frequency. Optionally, the dip function may extend from s₂ to spectral index 0, hence, q′_{f} may not comprise the first guard interval, but only the second guard interval. As shown in FIG. 2 b optionally no guard interval may be present so that a dip interval may span from index 0 to the pitch frequency.

According to embodiments, a position and/or width of such a first and/or second guard interval may be defined in a fixed manner or chosen in an adaptive manner. A spectral weighting as defined by such a guard interval may hence have a fixed predefined shape, e.g. according to a predefined function, or such a function may be adaptable during the coding procedure. As an example, in the first and/or second guard interval, q′_{f} may have a constant value (e.g. constant over the whole guard interval), and as explained before, this value may be a fixed value or an adaptable value. As an example, a respective guard interval may have a fixed spectral width of 5 spectral indices (e.g. in the case of a second guard interval, so that pitch frequency−s₂=5).

In the following further features, functionalities and details according to embodiments of the invention are discussed.

To address the need for additional or, in other words, improved ALFE for tonal, harmonic signals in audio transform coding, a frame-wise pitch adaptive method is proposed according to embodiments which
derives a pitch (fundamental frequency) p_{f} (e.g. pitch frequency) for frame f from bitstream parameters,
applies dip shaped, for example, parabola-shaped (de)emphasis on multiple spectral coefficients below p_{f},
   where the multiple spectral coefficients are associated with a spectral representation (i. e., spectrum) obtained by a time-to-frequency transform of the time signal associated with f. In other words, the pitch p_{f} may be determined from coding parameters (e.g. a fundamental frequency related parameter 113) already included in the bitstream (e.g. 101) for frame f, and when such a p_{f} value cannot be determined from the bitstream (e. g., because no fundamental frequency related coding parameters needed for the pitch derivation are present in the bitstream for frame f), no ALFE according to the invention may optionally be applied in the spectrum associated with f. As an example, the coding mode parameter 114 may indicate whether such a pitch frequency can be determined. The time-frequency transform may be a MDCT, and ‘below p_{f}’ may mean at spectral coefficient frequencies (represented by bin indices) lower than the spectral coefficient frequency (i. e., lower than the bin index) associated with p_{f}. The term ‘parabola-shaped (de)emphasis’ may indicate that either the encoder-side emphasis or decoder-side deemphasis factors follow the shape of a parabola across frequency.

In the following preferred embodiments are disclosed:

Let p_{f} be a pitch value (e.g. pitch frequency), as an example measured in units of spectral bin indices, for a given frame f. This pitch value is, preferably, derived (i. e., determined) from fundamental frequency related parameters (e.g. 113) contained or comprised in side-information associated with f and written to a bitstream (e.g. 101) by an audio transform encoder. Such parameters may, e. g, represent a time-domain fundamental frequency lag If and/or a frequency-domain periodic distance d_{f} between spectral peaks, typically used as parameters for harmonic post-filtering or long-term prediction.

When I_{f} information is available for a frame (i. e., contained in the bitstream (e.g. 101) for f), the pitch value may, preferably, be derived as follows, where rₛ is the codec's sampling rate (Hence, the following functionality may optionally be included in spectral shaping function determination unit 120):

$${p}_{f} = round ( {r}_{S} / ( number of frames per second \cdot 2 \cdot {l}_{f} ) )$$

with, usually, as an example, r_{S}=32000 or 48000 (i. e., 32 or 48 kHz), number of frames per second=50 (i. e., 20-ms frames), and 0<I_{f}<rₛ/100. The round( ) operator performs truncation of the result of the calculation to the nearest integer value (bin indices are integer values). It is worth noting that, when using the codec's Nyquist rate r_{N}=rₛ/2 instead of r_{S}, p may simply be

$${p}_{f} = round ( {r}_{N} / ( number of frames per second \cdot {l}_{f} ) ) .$$

When, instead of I_{f}, a spectral distance information d_{f} is available for f in the bitstream, the derivation of p_{f} may simply involve a rounding of the, possibly fractional, value of d_{f}:

$${p}_{f} = round ( {d}_{f} ) .$$

When, finally, both If and d_{f} data are available in the bitstream, p_{f} may, optionally, be obtained as

$${p}_{f} = round ( max ( {d}_{f} , {r}_{N} / ( number of frames per second \cdot {l}_{f} ) ) )$$

or an equivalent formulation using rₛ. Then, using p_{f}, two variations of ALFE according to embodiments are possible.

### ALFE Variant 1: Spectral Support Proportional to p_{f}

Let x_{f} and y_{f} be the input and reconstructed (after quantization) spectra, respectively, for frame f, with y_{f}(i)=q_{f}(i)·round(x_{f}(i)/q_{f}(i))=q_{f}(i)·round(x_{f}(i)·n_{f}(i)), where i is a bin index and q_{f}(i) is the quantization stepsize at every i. In the absence of ALFE, q_{f} is typically constant across i, but according to this aspect of the invention, q_{f} exhibits a parabola-shaped dip between bin index 0 and p_{f}. In other words, the range of spectral coefficients affected by the parabola-shaped attenuation of q_{f} equals pf and, preferably, with c_{f}=p_{f}/2 defined,

$${q}_{f}^{′} ( i ) = {q}_{f} ( i ) \cdot ( a + b \cdot ( 1 / {c}_{f}^{2} ) \cdot {( i - {c}_{f} )}^{2} )$$

for all i<p_{f}. The inverses of the deemphasis factors q′_{f} are the emphasis factors n′_{f}=1/q′_{f}, where q′_{f} includes the initial quantizer stepsize q_{f} as a multiplier. Preferably, a=¼, b=¾.

### ALFE Variant 2: Spectral Support Independent of p_{f}

The above-described ALFE variant was found to work as desired but, due to the large set of possible values for p_{f} and, thereby, c_{f}, it is hard to implement in fixed-point arithmetic. In addition, it may require p_{f} divisions at the encoder side, see n′_{f}, i. e., the computational complexity of ALFE v.1 is proportional to p_{f}. A lower-complexity ALFE, with a fixed number of operations per f and the possibility for simple fixed-point implementations may be devised by changing the definition of the parabolic center bin c_{f} to c_{f}=p_{f}−ß, ß>0, and

$${q}_{f}^{′} ( i ) = {q}_{f} ( i ) \cdot ( a + b \cdot ( 1 / {β}^{2} ) \cdot {( i - {c}_{f} )}^{2} )$$

for all max(0, p_{f}−2ß)≤i<p_{f}. With a power-of-two value for ß, this variant allows a fixedpoint implementation with fixed, low complexity in both q′_{f} and n′_{f}. Preferably, ß=8 or 4.

Notice that, in the above embodiments, the deemphasis factors q′_{f} follow a parabolic “v” shape in the lower frequencies (below p_{f}). As a result, the corresponding encoder-side emphasis (or normalization) factors n′_{f} follow a bell shape in the same spectral range. It is obvious that the reverse may also be realized, by designing parabolic “\hat{ }” shaped emphasis factors (i. e., peaking at c_{f}) and inversely bell shaped decoder-side deemphasis factors. However, since such a configuration would generally be computationally more complex at the decoder side, where a low complexity is desirable, it is not discussed further herein.

To conclude, it shall be noted that, when a strength parameter associated with a longterm predictor and/or harmonic post-filter is available in the bitstream for frame f, such strength information may be used to adapt the above ALFE parameters a and b, so as to use strong ALFE in frames with high long-term prediction and/or harmonic post-filtering strength, and weak ALFE in frames f with low such prediction and/or post-filter strength.

For example, given a 2-bit strength parameter s_{f}, representing a long-term prediction and/or harmonic post-filtering gain, b=0.25·s_{f}, a=1−b is, preferably used in q′_{f} and n′_{f}.

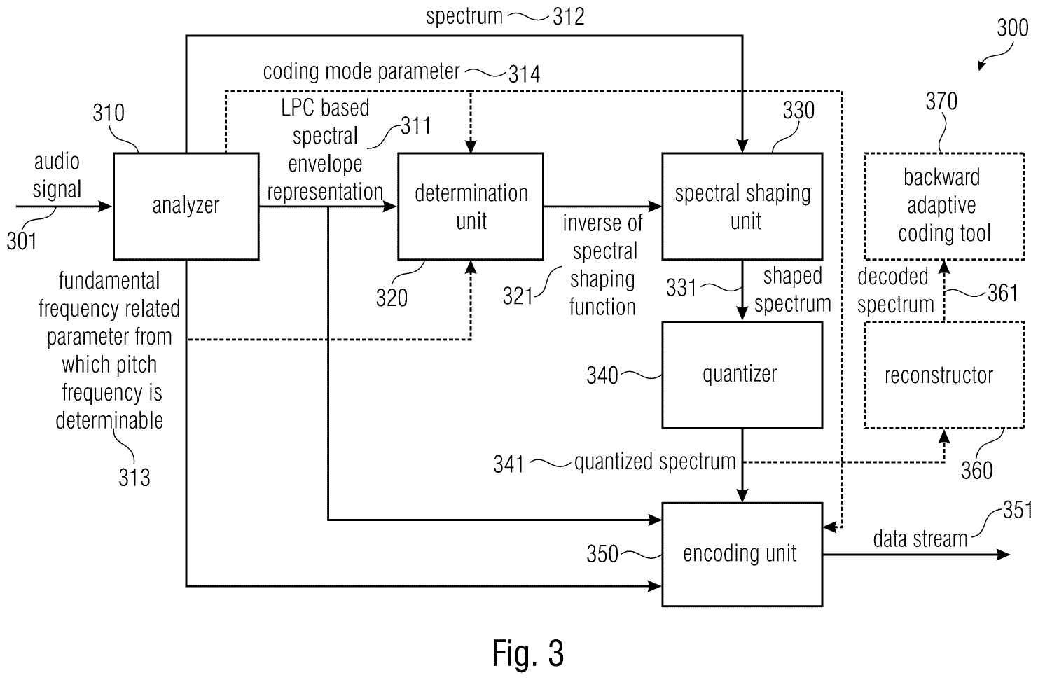

FIG. 3 shows a schematic view of an encoder according to embodiments of the invention. Encoder 300 comprises an analyzer 310, a determination unit 320, a spectral shaping unit 330, a quantizer 340 and an encoding unit 350.

The encoder 300 is configured to receive an audio signal 301, wherein the audio signal 301 comprises an information about a predetermined frame among consecutive frames. Using analyzer 310, the encoder 300 is configured to determine a linear prediction coefficient, LPC, based spectral envelope representation 311 and a spectrum 312.

According to a first example, encoder 300 is configured to determine, using determination unit 320 an inverse of a spectral shaping function 321 from the linear prediction coefficient based spectral envelope representation 311 using a first manner below a pitch frequency, and a second manner above the pitch frequency. The inverse of the spectral shaping function 321 is determined such that it is, at a predetermined spectral position, higher if the pitch frequency is spectrally higher than the predetermined spectral position, than compared to if the pitch frequency is spectrally lower than the predetermined spectral position. An example of such an inverse of a spectral shaping function 321 is shown with n′_{f} in FIG. 2 b.

Optionally, the pitch frequency may be a predetermined parameter, or the encoder 300 may determine a respective pitch frequency based on the audio signal 301. In the latter case, for example analyzer 310, as shown, may be configured to provide a respective information for a decoding, in the form of a fundamental frequency related parameter 313 from which the pitch frequency is determinable, to encoding unit 350.

Using spectral shaping unit 330, the encoder 300 is configured to spectrally shape the spectrum 312 using the inverse of the spectral shaping function 321 to obtain a shaped spectrum 331. The shaped spectrum 331 is provided to the quantizer 340 to obtain a quantized spectrum 341.

Using encoding unit 350, the quantized spectrum 341, the linear prediction coefficient based spectral envelope representation 311, and a fundamental frequency related parameter from which the pitch frequency is determinable 313 are encoded into a data stream 351.

According to a second example, the determination unit 320 may be configured to determine an intermediate version of a spectral shaping function or of an inverse of the spectral shaping function from the linear prediction coefficient based spectral envelope representation 311.

Furthermore, encoder 300 may be configured to, below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function or a local spectral increase in the intermediate version of the inverse of the spectral shaping function by aligning an increase function with an interval whose upper limit coincides with, or is, by a predetermined guard interval width value offset towards DC from, the pitch frequency, and applying the increase function thus aligned to the intermediate version of the inverse of the spectral shaping function.

In the example, as shown in FIG. 3, the determination unit 320 may be configured to determine the intermediate version of the inverse of the spectral shaping function from the linear prediction coefficient based spectral envelope representation 311. Furthermore, the determination unit 320 may be configured to, below a pitch frequency determined from the fundamental frequency related parameter 331 (which may hence as shown optionally be provided to determination unit 320), form a local spectral increase in the intermediate version of the inverse of the spectral shaping function by aligning an increase function with an interval whose upper limit coincides with, or is, by a predetermined guard interval width value offset towards DC from, the pitch frequency, and to apply the increase function thus aligned to the intermediate version of the inverse of the spectral shaping function.

As a result of the application of the increase function to the intermediate version of the inverse of the spectral shaping function, the inverse of spectral shaping function 321 may be provided to the spectral shaping unit 330 and used for the provision of the data stream 351 as explained in the context of the first example.

As another optional feature, encoder 300 comprises a reconstructor 360. Reconstructor 360 may comprise the same features, as a decoder 100. Decoder 360 is optionally provided with the quantized spectrum 341 and/or even (not shown) the data stream 351, in order to decode the spectrum as explained in the context of FIG. 1 and to use the decoded spectrum 361 in order to improve the encoding of the audio signal 301. Therefore, as another optional feature, encoder 300 comprises an optional backward adaptive coding tool 370, which may comprise a plurality of coding tools and which may allow to implement a feedback loop for the encoder 300 in order to improve the encoding procedure. For example, the reconstructed spectrum might be used for the coding of one or more subsequent frames and as the reconstructed spectrum is also available to the decoder, the encoder would maintain synchronousity with the decoder. Corresponding to backward adaptive coding tool 370, the decoder might have a corresponding backward adaptive coding tool 150, as discussed before, so as to receive spectrum 131 and perform the same sort of processing, for example prediction, as unit 370. Therefore, respective parameters, e.g. prediction parameters may be inserted in the bitstream for the corresponding unit at decoder side.

For example, using the optional backward adaptive coding tool 370, encoder 300 may be configured to perform a frequency-domain prediction, e.g. in accordance with MPEG-H Audio (e.g. ISO/IEC (MPEG-H), International Standard 23008-3:2022, “High efficiency coding and media delivery in heterogeneous environments-Part 3: 3D audio,” August 2022.) or long-term prediction (LTP) as in AAC (1990s years). An approach in accordance with MPEG-H Audio may be used according to U.S. application Ser. No. 16/802,397. An approach according to “improved LTP” may be used according to Goran Markovic et al. (application 2020/2021). According to embodiments, different variants may be used. As an example, a fundamental frequency parameter, for example a pitch information, may be used for such a prediction. Accordingly, a respective fundamental frequency information, e.g. pitch frequency information, may be provided to the backward adaptive coding tool 370 (and optionally be determined based on the audio signal 301 by encoder 300), for example, in form of the fundamental frequency related parameter 313. Such an information may be encoded in data stream 351.

Hence, the above explained determination of the intermediate shaping function and reduction function, as well as pitch frequency determination based on fundamental frequency related parameter 113 may be performed in reconstructor 360 for providing the decoded spectrum 361. Reconstructor 360 may, for example, obtain an information about the fundamental frequency related parameter 313 via data stream 351 or may optionally be provided directly with such a parameter.

According to third example, analyzer 310 may be configured to determine besides the LPC based spectral envelope representation 311 a coding mode parameter 314. The coding mode parameter 314 is provided, as an optional feature, to the determination unit 320 and to encoding unit 350 in order to be encoded into data stream 351.

The encoder 300 may optionally be configured to, if the coding mode parameter 314 fulfils a predetermined criterion, determine a spectral shaping function from the linear prediction coefficient based spectral envelope representation using a first manner and, if the coding mode parameter does not fulfil the predetermined criterion, determine the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency.

Alternatively or in addition, the encoder 300 may optionally be configured to, if the coding mode parameter 314 fulfils the predetermined criterion, determine an inverse of a spectral shaping function 321 from the linear prediction coefficient based spectral envelope representation 311 using a first manner and, if the coding mode parameter does not fulfil the predetermined criterion, determine the inverse of the spectral shaping function 321 from the linear prediction coefficient based spectral envelope representation 311 using a second manner, wherein the first manner and the second manner differ so that a difference between the inverse of the spectral shaping function as determined from the linear prediction coefficient based spectral envelope representation 311 using the first manner in case of the coding mode parameter fulfilling the predetermined criterion, minus the inverse of the spectral shaping function as determined from the linear prediction coefficient based spectral envelope representation using the second manner in case of the coding mode parameter not fulfilling the predetermined criterion, comprises an inverse of a dip below a pitch frequency.

Again the functionality for the determination of the inverse of the spectral shaping function may be implemented in determination unit 320, and the functionality for the determination of the spectral shaping function may be implemented in decoder 360 in order to improve the encoding of data stream 351.

It is to be noted that quantizer 340 may determine a quantization step size of the spectrum 312. As an example, the spectral shaping unit 330 may multiply spectrum 312 by the spectral curve as defined by the inverse 321 of the spectral shaping function and then, quantizer 340 may use a spectrally constant quantization step size for the whole spectrum 331.

When considered as a whole, spectral shaping unit 330 and quantizer 340 may represent or may be seen as a quantization unit with spectrally varying quantization step size. Accordingly, as an example, the inverse 321 of the spectral shaping function may represent a spectrally varying scaling function entering such a quantization unit with spectrally varying quantization step size, wherein the larger the this function is, the smaller the quantization step size is which his applied by quantization unit 340 with spectrally varying quantization step size. Accordingly, the decoding side may optionally be informed of the variation of the quantization step size, for example in the form of scale factors and/or LPC based spectral envelope representation 311, which, by way of the just-described relationship between quantization step size on the one hand and spectral shaping function on the other hand, control the step size spectrally. Whatever view is applied, the scale factors (e.g. as derived by the LPC based spectral envelope representation 311 via a conversion) may be defined at a spectral resolution which is lower than, or coarser than, the spectral resolution at which the quantized spectral levels of the quantized spectrum describe the spectral line-wise representation of the audio signal's spectrogram. For example, such scale factor bands may be Bark bands.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] 3GPP, ETSI TS (1)26.441, “EVS Codec: General Overview,” ver. 12, rel. 12, October 2014.
[2] 3GPP, ETSI TS (1)26.445, “EVS Codec: Detailed algorithmic description,” May 2022.

1. Audio decoder configured to, for a predetermined frame among consecutive frames,
decode, from a data stream,
a quantized spectrum;
a linear prediction coefficient based spectral envelope representation, and
a fundamental frequency related parameter,
determine a spectral shaping function from the linear prediction coefficient based spectral envelope representation using a first manner below a pitch frequency determined from the fundamental frequency related parameter, and a second manner above the pitch frequency, and
spectrally shape the quantized spectrum using the spectral shaping function to obtain a dequantized spectrum, and
reconstruct the predetermined frame using the dequantized spectrum,
wherein the audio decoder is configured so that
the spectral shaping function is, at a predetermined spectral position, lower if the pitch frequency is spectrally higher than the predetermined spectral position, than compared to if the pitch frequency is spectrally lower than the predetermined spectral position.

2. Audio decoder of previous claim 1, so that an amount at which the spectral shaping function is, at the predetermined spectral position, lower if the pitch frequency is spectrally higher than the predetermined spectral position, than compared to if the pitch frequency is spectrally lower than the predetermined spectral position, corresponds to a dip function with using a distance between the predetermined spectral position and the pitch frequency as an attribute of the dip function.

3. Audio decoder of claim 2, configured to
determine the dip function in a manner depending on the pitch frequency so that the dip function comprises a local extremum at half of the pitch frequency or half of a difference of the pitch frequency minus a predetermined guard interval width value, monotonically increases between zero-frequency and the local extremum, and monotonically decreases between the local extremum and the pitch frequency or the pitch frequency minus a predetermined guard interval width value.

4. Audio decoder of claim 2, configured so that the dip function has a unimodal shape, which is independent from the pitch frequency and has a dip interval width, and the dip function has a constant value for the distance being larger than the dip interval width.

5. Audio decoder of claim 1, configured to, determine the spectral shaping function from the linear prediction coefficient based spectral envelope representation, by
determining an intermediate version of the spectral shaping function from the linear prediction coefficient based spectral envelope representation, and
below the pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function.

6. Audio decoder of claim 1, configured to
decode, from a data stream, a coding mode parameter for each of the consecutive frames, and
decide based on the coding mode parameter so as to, for frames for which the coding mode parameter fulfils a predetermined criterion,
decode a fundamental frequency related parameter from the data stream,
determine a spectral shaping function from the linear prediction coefficient based spectral envelope representation using the first manner below a pitch frequency determined from the fundamental frequency related parameter, and the second manner above the pitch frequency, and
for frames for which the coding mode parameter does not fulfil the predetermined criterion,
determine a spectral shaping function from the linear prediction coefficient based spectral envelope representation using one manner over all frequencies.

7. Audio decoder configured to, for a predetermined frame among consecutive frames,
decode, from a data stream,
a quantized spectrum;
a linear prediction coefficient based spectral envelope representation, and
a fundamental frequency related parameter,
determine an intermediate version of a spectral shaping function from the linear prediction coefficient based spectral envelope representation,
below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function, and
spectrally shape the quantized spectrum using the spectral shaping function to obtain a dequantized spectrum, and
reconstruct the predetermined frame using the dequantized spectrum.

8. Audio decoder of claim 5, configured to
decode, from a data stream, a coding mode parameter for each of the consecutive frames, and
decide based on the coding mode parameter so as to, for frames for which the coding mode parameter fulfils a predetermined criterion,
decode a fundamental frequency related parameter from the data stream,
determine an intermediate version of a spectral shaping function from the linear prediction coefficient based spectral envelope representation,
below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function, and
for frames for which the coding mode parameter does not fulfil the predetermined criterion,
determine the spectral shaping function so as to be equal to the intermediate version of the spectral shaping function.

9. Audio decoder configured to, for a predetermined frame among consecutive frames,
decode, from a data stream,
a quantized spectrum;
a linear prediction coefficient based spectral envelope representation, and
a coding mode parameter,
if the coding mode parameter fulfils a predetermined criterion, determine a spectral shaping function from the linear prediction coefficient based spectral envelope representation using a first manner and, if the coding mode parameter does not fulfil the predetermined criterion, determine the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency, and
spectrally shape the quantized spectrum using the spectral shaping function to obtain a dequantized spectrum, and
reconstruct the predetermined frame using the dequantized spectrum.

10. Audio decoder of claim 6, configured to, if the coding mode parameter fulfils the predetermined criterion,
decode, from the data stream, a fundamental frequency related parameter for the predetermined frame, and
derive the pitch frequency based on the fundamental frequency related parameter.

11. Audio decoder of claim 6, wherein the dip follows a dip function and the audio decoder is configured to determine the dip function in a manner depending on the pitch frequency so that the dip function comprises a local extremum at half of the pitch frequency or half of a difference of the pitch frequency minus a predetermined guard interval width value, monotonically deceases between zero-frequency and the local extremum, and monotonically increases between the local extremum and the pitch frequency or the pitch frequency minus the predetermined guard interval width value.

12. Audio decoder of claim 6, wherein the dip follows a dip function and the dip function has a dip shape, which is independent from the pitch frequency and has a dip interval width whose upper limit is aligned with the pitch frequency, or the pitch frequency minus a predetermined guard interval width value, and the difference is zero for frequencies between zero frequency and the pitch frequency minus the dip interval width or between zero frequency and the pitch frequency minus the dip interval width and minus the predetermined guard interval width value.

13. Audio decoder of claim 5, configured to
determine the reduction function in a manner depending on the pitch frequency.

14. Audio decoder of claim 5, configured to
determine the reduction function in a manner depending on the pitch frequency so that the reduction function comprises a local extremum leading to a local extreme of reduction of the spectral shaping function at a spectral position which depends on the pitch frequency.

15. Audio decoder of claim 5, configured to
determine the reduction function in a manner depending on the pitch frequency so that the reduction function comprises a local extremum leading to a local extreme of reduction of the spectral shaping function at a spectral position which corresponds to half of the pitch frequency.

16. Audio decoder of claim 5, configured to
determine the reduction function in a manner depending on the pitch frequency so that the reduction function comprises a local extremum leading to a local extreme of reduction of the spectral shaping function at a spectral position which corresponds to half of the pitch frequency with the reduction function being of monotonically deceasing reducing strength between zero-frequency and the spectral position, and monotonically increasing reducing strength between the spectral position and the pitch frequency.

17. Audio decoder of claim 5, configured to
determine the reduction function in a manner depending on the pitch frequency so that the reduction function comprises a local extremum leading to a local extreme of reduction of the spectral shaping function at a spectral position which corresponds to the pitch frequency minus a predetermined interval width value.

18. Audio decoder of claim 5, configured to
determine the reduction function in a manner depending on the pitch frequency so that the reduction function comprises a local extremum leading to a local extreme of reduction of the spectral shaping function at a spectral position which corresponds to the pitch frequency minus a predetermined interval width value with the reduction function being of no reducing strength between zero-frequency and the spectral position minus the interval width, of monotonically deceasing reducing strength between the spectral position minus the interval width and the spectral position, and of monotonically increasing reducing strength between the spectral position and the spectral position plus the interval width value.

19. Audio decoder according to claim 1, configured to
Decode, from the data stream, the quantized spectrum
by entropy decoding and/or
in form of spectral coefficient levels of an MDCT.

20. Audio decoder according to claim 1, configured to reconstruct the predetermined frame using the dequantized spectrum by
applying a spectrum-to-time transformation to the quantized spectrum, and/or
using an overlap-add aliasing cancellation process with respect to one or more temporally neighbouring frames.

21. Audio encoder configured to, for a predetermined frame among consecutive frames,
determine a linear prediction coefficient based spectral envelope representation and a spectrum,
determine an inverse of a spectral shaping function from the linear prediction coefficient based spectral envelope representation using a first manner below a pitch frequency, and a second manner above the pitch frequency, and
spectrally shape the spectrum using the inverse of the spectral shaping function to obtain a shaped spectrum and quantize the shaped spectrum to obtain a quantized spectrum, and
encode, into a data stream,
the quantized spectrum;
the linear prediction coefficient based spectral envelope representation, and
a fundamental frequency related parameter from which the pitch frequency is determinable,
wherein the audio encoder is configured so that
the inverse of the spectral shaping function is, at a predetermined spectral position, higher if the pitch frequency is spectrally higher than the predetermined spectral position, than compared to if the pitch frequency is spectrally lower than the predetermined spectral position.

22. Audio encoder configured to, for a predetermined frame among consecutive frames,
determine a linear prediction coefficient based spectral envelope representation and a spectrum,
determine an intermediate version of a spectral shaping function or of an inverse of the spectral shaping function from the linear prediction coefficient based spectral envelope representation,
below a pitch frequency determined from the fundamental frequency related parameter, form a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function or a local spectral increase in the intermediate version of the inverse of the spectral shaping function by aligning an increase function with an interval whose upper limit coincides with, or is, by a predetermined guard interval width value offset towards DC from, the pitch frequency, and applying the increase function thus aligned to the intermediate version of the inverse of the spectral shaping function, and
spectrally shape the spectrum using the inverse of the spectral shaping function to obtain a shaped spectrum and quantize the shaped spectrum to obtain a quantized spectrum, and
encode, into a data stream,
the quantized spectrum;
the linear prediction coefficient based spectral envelope representation, and
a fundamental frequency related parameter from which the pitch frequency is determinable.

23. Audio encoder configured to, for a predetermined frame among consecutive frames,
determine a linear prediction coefficient based spectral envelope representation, a spectrum and a coding mode parameter,
if the coding mode parameter fulfils a predetermined criterion, determine a spectral shaping function from the linear prediction coefficient based spectral envelope representation using a first manner and, if the coding mode parameter does not fulfil the predetermined criterion, determine the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency, or if the coding mode parameter fulfils the predetermined criterion, determine an inverse of a spectral shaping function from the linear prediction coefficient based spectral envelope representation using a first manner and, if the coding mode parameter does not fulfil the predetermined criterion, determine the inverse of the spectral shaping function from the linear prediction coefficient based spectral envelope representation using a second manner, wherein the first manner and the second manner differ so that a difference between the inverse of the spectral shaping function as determined from the linear prediction coefficient based spectral envelope representation using the first manner in case of the coding mode parameter fulfilling the predetermined criterion, minus the inverse of the spectral shaping function as determined from the linear prediction coefficient based spectral envelope representation using the second manner in case of the coding mode parameter not fulfilling the predetermined criterion, comprises an inverse of a dip below a pitch frequency, and
spectrally shape the spectrum using the inverse of the spectral shaping function to obtain a shaped spectrum and quantize the shaped spectrum to obtain a quantized spectrum, and
encode, into a data stream,
the quantized spectrum;
the linear prediction coefficient based spectral envelope representation, and
the coding mode parameter.

24. Method for a predetermined frame among consecutive frames, the method comprising:
decoding, from a data stream,
a quantized spectrum,
a linear prediction coefficient based spectral envelope representation, and
a fundamental frequency related parameter;
determining a spectral shaping function from the linear prediction coefficient based spectral envelope representation using a first manner below a pitch frequency determined from the fundamental frequency related parameter, and a second manner above the pitch frequency,
spectrally shaping the quantized spectrum using the spectral shaping function to obtain a dequantized spectrum, and
reconstructing the predetermined frame using the dequantized spectrum;
wherein the determination of the spectral shaping function is performed, so that the spectral shaping function is, at a predetermined spectral position, lower if the pitch frequency is spectrally higher than the predetermined spectral position, than compared to if the pitch frequency is spectrally lower than the predetermined spectral position.

25. Method for a predetermined frame among consecutive frames, the method comprising:
decoding, from a data stream,
a quantized spectrum;
a linear prediction coefficient based spectral envelope representation, and
a fundamental frequency related parameter;
determining an intermediate version of a spectral shaping function from the linear prediction coefficient based spectral envelope representation,
below a pitch frequency determined from the fundamental frequency related parameter, forming a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function; and
spectrally shaping the quantized spectrum using the spectral shaping function to obtain a dequantized spectrum, and
reconstructing the predetermined frame using the dequantized spectrum.

26. Method for a predetermined frame among consecutive frames, the method comprising:
decoding, from a data stream,
a quantized spectrum;
a linear prediction coefficient based spectral envelope representation, and
a coding mode parameter;
if the coding mode parameter fulfils a predetermined criterion, determining a spectral shaping function from the linear prediction coefficient based spectral envelope representation using a first manner and, if the coding mode parameter does not fulfil the predetermined criterion, determining the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency; and
spectrally shaping the quantized spectrum using the spectral shaping function to obtain a dequantized spectrum; and
reconstructing the predetermined frame using the dequantized spectrum.

27. Method for a predetermined frame among consecutive frames, the method comprising:
determining a linear prediction coefficient based spectral envelope representation and a spectrum,
determining an inverse of a spectral shaping function from the linear prediction coefficient based spectral envelope representation using a first manner below a pitch frequency, and a second manner above the pitch frequency,
spectrally shaping the spectrum using the inverse of the spectral shaping function to obtain a shaped spectrum and quantize the shaped spectrum to obtain a quantized spectrum, and
encoding, into a data stream,
the quantized spectrum,
the linear prediction coefficient based spectral envelope representation, and
a fundamental frequency related parameter from which the pitch frequency is determinable.
wherein the determination of the inverse of the spectral shaping function is performed, so that the inverse of the spectral shaping function is, at a predetermined spectral position, higher if the pitch frequency is spectrally higher than the predetermined spectral position, than compared to if the pitch frequency is spectrally lower than the predetermined spectral position.

28. Method for a predetermined frame among consecutive frames, the method comprising:
determining a linear prediction coefficient based spectral envelope representation and a spectrum,
determining an intermediate version of a spectral shaping function or of an inverse of the spectral shaping function from the linear prediction coefficient based spectral envelope representation,
below a pitch frequency determined from the fundamental frequency related parameter, forming a local spectral reduction in the intermediate version of the spectral shaping function by aligning a reduction function with an interval whose upper limit coincides with, or is, by a predetermined guard interval width value offset towards DC from, the pitch frequency, and applying the reduction function thus aligned to the intermediate version of the spectral shaping function or a local spectral increase in the intermediate version of the inverse of the spectral shaping function by aligning an increase function with an interval whose upper limit coincides with, or is, by a predetermined guard interval width value offset towards DC from, the pitch frequency, and applying the increase function thus aligned to the intermediate version of the inverse of the spectral shaping function; and
spectrally shaping the spectrum using the inverse of the spectral shaping function to obtain a shaped spectrum and quantizing the shaped spectrum to obtain a quantized spectrum, and
encoding, into a data stream,
the quantized spectrum;
the linear prediction coefficient based spectral envelope representation, and
a fundamental frequency related parameter from which the pitch frequency is determinable.

29. Method for a predetermined frame among consecutive frames, the method comprising:
determining a linear prediction coefficient based spectral envelope representation, a spectrum and a coding mode parameter;
if the coding mode parameter fulfils a predetermined criterion, determining a spectral shaping function from the linear prediction coefficient based spectral envelope representation using a first manner and, if the coding mode parameter does not fulfil the predetermined criterion, determining the spectral shaping function from the linear prediction coefficient based spectral envelope representation using a second manner, wherein the first manner and the second manner differ so that a difference between the spectral shaping function as determined from the linear prediction coefficient based spectral envelope representation using the first manner in case of the coding mode parameter fulfilling the predetermined criterion, minus the spectral shaping function as determined from the linear prediction coefficient based spectral envelope representation using the second manner in case of the coding mode parameter not fulfilling the predetermined criterion, comprises a dip below a pitch frequency, or
if the coding mode parameter fulfils the predetermined criterion, determining an inverse of a spectral shaping function from the linear prediction coefficient based spectral envelope representation using a first manner and, if the coding mode parameter does not fulfil the predetermined criterion, determining the inverse of the spectral shaping function from the linear prediction coefficient based spectral envelope representation using a second manner, wherein the first manner and the second manner differ so that a difference between the inverse of the spectral shaping function as determined from the linear prediction coefficient based spectral envelope representation using the first manner in case of the coding mode parameter fulfilling the predetermined criterion, minus the inverse of the spectral shaping function as determined from the linear prediction coefficient based spectral envelope representation using the second manner in case of the coding mode parameter not fulfilling the predetermined criterion, comprises an inverse of a dip below a pitch frequency, and
spectrally shaping the spectrum using the inverse of the spectral shaping function to obtain a shaped spectrum and quantizing the shaped spectrum to obtain a quantized spectrum, and
encoding, into a data stream,
the quantized spectrum;
the linear prediction coefficient based spectral envelope representation, and
the coding mode parameter.

30. A computer program for performing the method according to claim 24, when the computer program runs on a computer.
